(19) United States
(12) Patent Application Publication
(10) Pub. No.: US 2008/0182158 A1
(43) Pub. Date: Jul. 31, 2008

(54) Battery system

(75) Inventors: Gary P. Houchin-Miller, Milwaukee, WI (US); Dale B. Trester, Milwaukee, WI (US); Steven J. Wood, Shorewood, WI (US)

Correspondence Address: FOLEY AND LARDNER LLP;SUITE 500, 3000 K STREET NW, WASHINGTON, DC, 20007, US

(73) Assignee: Johnson Controls- SAFT Advanced Power Solutions LLC

(21) Appl. No.: 12/000,560

(22) Filed: Dec. 13, 2007

Related U.S. Application Data
(60) Provisional application No. 60/874,940, filed on Dec. 14, 2006.

(51) Int. Cl. H01M 2/12; H01M 2/02; H01M 2/22

(52) U.S. Cl. 429/53; 429/179; 429/149; 429/160

(57) ABSTRACT

One embodiment of the disclosure relates to a battery having a housing. The housing has a first end and a second end. The second end has a protrusion. A terminal is located adjacent the first end of the housing and has a recess. The recess is configured to receive a protrusion of a second battery when two or more batteries are coupled together.

### RELATED APPLICATIONS

This application claims priority from U.S. Application 60/874,940, filed Dec. 14, 2006, incorporated herein by reference in its entirety. The present application also expressly incorporates herein by reference the entire disclosures of the following patent applications: U.S. Patent Application No. 60/808,386 filed May 25, 2006; U.S. Patent Application No. 60/795,818 filed Apr. 28, 2006; and U.S. Patent Application No. 60/816,501 filed Jun. 26, 2006.

### BACKGROUND

The present inventions relate generally to batteries or cells (e.g., lithium batteries or cells such as lithium-ion batteries or cells) and battery assemblies or modules that utilize such batteries or cells. The present inventions relate more particularly to battery cell stick modules for use in vehicles such as hybrid electric and electric vehicles.

Battery modules for use in vehicles and other suitable applications are generally known. However, such known battery modules tend to have certain disadvantages. For example, known methods of coupling cells together tend to be relatively cumbersome and require the use of several additional parts. Additionally, where cells are arranged end-to-end (as in a stick module), it would be beneficial to provide structures that accommodate venting structures that allow gas and/or effluent to escape from within individual batteries.

Accordingly, it would be desirable to provide an improved design for batteries and battery assemblies that provide for relatively simple and efficient assembly and which may be readily adapted for use in existing battery assemblies. It would also be desirable to provide a mechanism for coupling batteries together in an end-to-end manner. It would be advantageous to provide batteries and/or battery systems that include any one or more of these or other advantageous features as will be apparent to those reviewing the present disclosure.

### SUMMARY

One embodiment of the disclosure relates to a battery having a housing. The housing has a first end and a second end. The second end has a protrusion. A terminal is located adjacent the first end of the housing and has a recess. The recess is configured to receive a protrusion of a second battery when two or more batteries are coupled together.

Another embodiment of the disclosure relates to a battery module having a first battery and a second battery. The first battery includes a housing, a first end, and a second end opposite the first end. The first end has a terminal. The terminal has a recess. The second end has a protrusion. The second battery includes a housing, a first end, and a second end opposite the first end. The first end has a terminal. The terminal has a recess. The second end has a protrusion. The protrusion of the second battery is received in the recess of the first battery when the batteries are coupled end to end.

### BRIEF DESCRIPTION OF THE DRAWINGS

FIG. 1 is an isometric view of vehicle having a battery system provided therein.

FIG. 2 is an isometric view of a battery system having a battery module provided therein.

FIG. 3 is an isometric view of a battery module or assembly according to an exemplary embodiment.

FIG. 4 is another isometric view of the battery module or assembly shown in FIG. 3.

FIG. 5 is an isometric view of a battery or cell used in the battery module or assembly shown in FIG. 3 according to an exemplary embodiment.

FIG. 6 is another isometric view of the battery or cell shown in FIG. 5.

FIGS. 7-8 are isometric views of a member or element (e.g., an insulative connector) used in the battery module or assembly shown in FIG. 3.

FIGS. 9-10 are isometric views of a battery or cell according to another exemplary embodiment.

### DETAILED DESCRIPTION

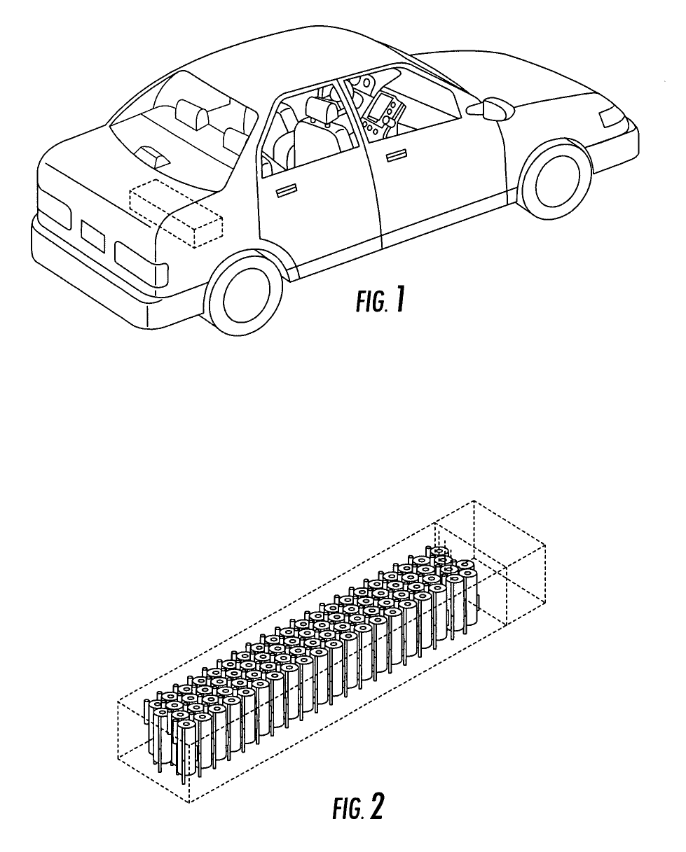

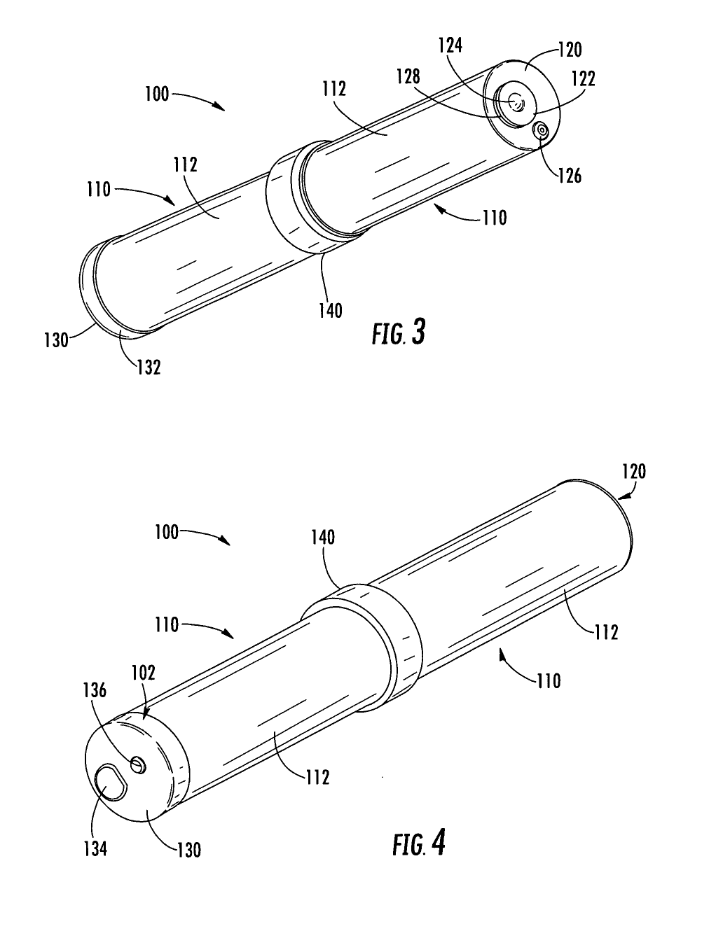

Referring to FIGS. 3-4, a portion of a battery module or assembly 100 is shown according to an exemplary embodiment. According to an exemplary embodiment, the battery module may be part of a battery system included in a vehicle that includes any suitable number of battery modules provided therein (see, e.g., FIGS. 1 and 2; according to other exemplary embodiments, the battery system may be provided elsewhere in a vehicle than the location shown in FIG. 1). The battery module 100 comprises a plurality of cells 110, each of which includes a housing or casing 112 (e.g., a can), a first end 120, and a second end 130. An end cap 132 is provided at the second end 130 of the cells 110. The battery module is configured to store and deliver an electrical charge for an application (e.g., a gasoline-electric hybrid vehicle, etc.). However, the cells of the battery module assembly may be used in any suitable application and the scope of the embodiments described herein are intended to include all such applications. It should be understood that the number of cells included in a battery module will depend on a variety of factors, and that all such battery modules are intended to be included in the scope of the present disclosure.

The cells are shown as generally cylindrical bodies. According to an exemplary embodiment, the battery includes electrodes (not shown) provided therein that are rolled into a generally cylindrical electrode roll. It should be noted that according to other exemplary embodiments, the shapes of the cells may differ. Features described herein should be understood as having application in other embodiments in which cells of different sizes, shapes, and configurations are used (e.g., flat plate cells, oval shaped cells, etc.).

A terminal 122 is provided at the first end of the cells, and has a recess or dimple 124 provided therein. The terminal is conductively coupled to one or more electrodes (not shown) provided within the cell. According to an exemplary embodiment, the terminal 122 is a negative terminal and is formed from copper or a copper alloy. According to other exemplary embodiments, the terminal 122 may be a positive terminal and/or may be formed of a different material. A seal 128 is provided between the terminal 124 and the first end 120 of the cell 110.

According to an exemplary embodiment, the housings 112 of the cells are conductively coupled to a second electrode in the cell and is configured to act as the second terminal of the cell.

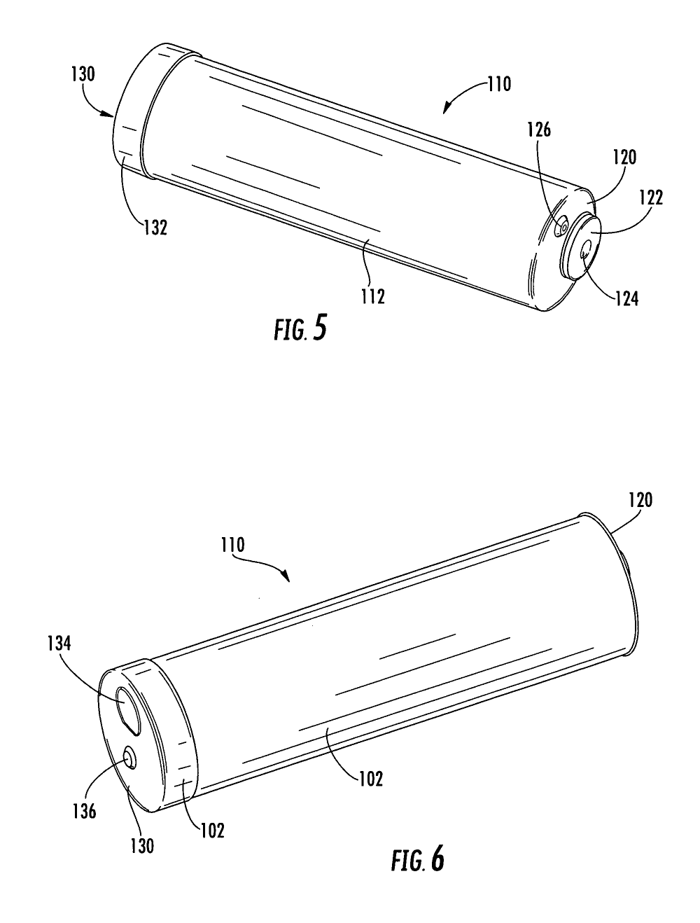

The second end 130 of the cell 110 includes a region or area 134 (see FIGS. 4 and 6) that is shown as a weakened or perforated region to provide a safety feature that may break away from the cell in the event that a pressure relief device (e.g., a one or two-stage venting mechanism as disclosed variously in the patent applications incorporated by reference herein may be provided as part of the battery and provided at least partially within the end cap 132 at the second end 130 of the battery) fails. According to various exemplary embodiments, the weakened area 134 may be provided by “scoring” or other suitable methods of weakening the material of the end wall of end cap 132, or may be a separate material provided in the end wall of end cap 132.

As shown in FIGS. 4 and 6, a protrusion or extension 136 is provided on the end cap 132 that is configured to engage a recess or dimple (e.g., recess 124) provided in a terminal of an adjacent battery when cells are arranged in an end-to-end manner. In this manner, the protrusion 136 provides both an electrical connection between adjacent cells and allows for Poke Yoke fitment between cells when the protrusion 136 is aligned with the recess 124 in the terminal 122 of an adjacent cell. According to an exemplary embodiment, the end cap 132 is welded to the housing 112 of the cell 110. According to other embodiments, the end cap may be coupled to the housing in any other suitable manner that mechanically and electrically couples it to the housing.

A member or element 140 (e.g., an insulator cap) as shown in FIGS. 3-4 in the form of a connector is provided between adjacent cells when the battery module 100 is assembled. According to an exemplary embodiment, the member 140 is made of a generally insulative or non-conductive material (e.g., a polymeric material such as polypropylene or other suitable polymers). One advantageous feature of using an insulative material for the member 140 is that the containers for adjacent cells will be prevented from coming into contact with each other, which may result in the formation of a short.

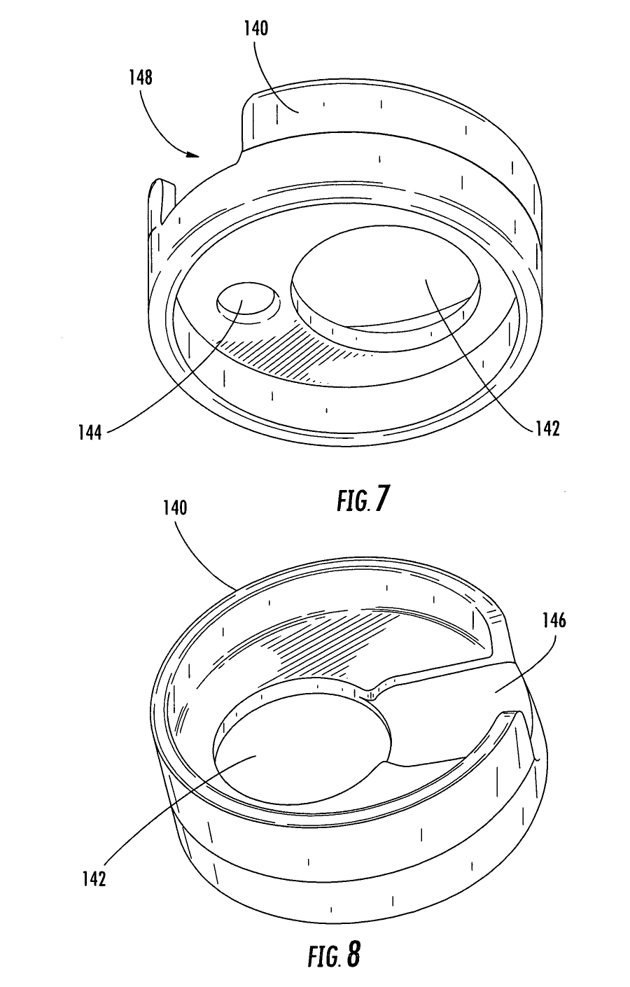

As illustrated in FIGS. 7-8, an aperture 142 is provided through which the protrusion 136 may contact the terminal 122 of an adjacent cell (e.g., by engaging the dimple 124 formed in the terminal 122 according to one exemplary embodiment). That is, the terminal 122 is aligned with the aperture 142 formed in the member 140 to allow contact with a protrusion formed on an end cap of an adjacent cell. A recess or dimple 144 is provided in the member 140 to accommodate a rivet 126 (FIG. 3) or other feature used to seal a fill hole provided in the first end of a cell.

In the event that pressure is required to be released from one of the cells, as mentioned above and described in the patent applications incorporated herein by reference, the area or region 134 of the end cap 130 may break away from the end cap. To prevent the material from the area 134 from making contact with the adjacent cell, a recessed area 146 is provided in the member 140 that will allow gas or effluent to escape from the cell and exit the battery module 100 through an opening or aperture 148 formed in the member 140. Aperture 148 is adjacent and in fluid communication with recessed area 146.

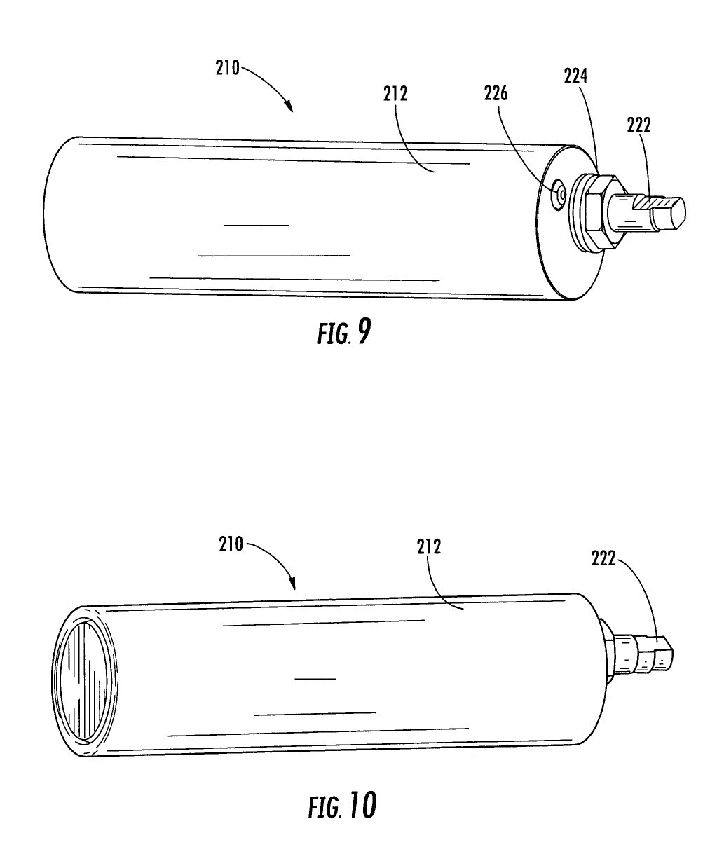

FIGS. 9-10 illustrate a battery or cell 210 according to another exemplary embodiment. The battery 210 includes a housing 212, a fill hole and rivet or other sealing device 226, and a terminal 222 extending from an end of the battery 210. A seal is provided between the terminal and the end of the housing. According to an exemplary embodiment, the battery 210 is configured for being coupled to other batteries by providing an electrical and mechanical connection between the terminal 222 and a terminal of an adjacent battery.

According to an exemplary embodiment, a battery or cell (e.g., a lithium-ion battery) is provided that includes a housing, a first end, and a second end. The first end includes a crimped terminal having a recess or dimple provided therein, and the second end includes a protrusion or extension. The recess or dimple is configured to engage a protrusion or extension included in another cell when two or more cells are coupled together in an end-to-end manner. A member or element (e.g., an insulative ring) is provided intermediate or between adjacent cells to prevent the ends of adjacent batteries from coming into contact with each other and to provide a space where a venting mechanism may operate without contacting an adjacent cell.

The construction and arrangement of the elements of the batteries and battery modules as shown in the illustrated and other exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein (e.g., materials for formation of the conductive and insulating components, technology for the internal components of the cell, the shape of the cells, etc.). For example, elements shown as integrally formed may be constructed of multiple parts or elements, the position of elements may be reversed or otherwise varied, and the nature or number of discrete elements or positions may be altered or varied. It should be noted that the elements and/or assemblies of the battery module may be constructed from any of a wide variety of materials that provide sufficient strength or durability (such as aluminum, steel, copper) in any of a wide variety of colors, combinations and suitable materials. Other substitutions, modifications, changes and omissions may be made in the design, operating conditions and arrangement of the preferred and other exemplary embodiments without departing from the scope of the present inventions. The order or sequence of any process or method steps may be varied or re-sequenced according to alternative embodiments. Other substitutions, modifications, changes and omissions may be made in the design, operating configuration and arrangement of the preferred and other exemplary embodiments without departing from the spirit of the present inventions as expressed herein.

What is claimed is:

1. A battery, comprising:
a housing having a first end and a second end, the second end having a protrusion; and
a terminal located adjacent the first end of the housing and having a recess; the recess configured to receive a protrusion of a second battery when two or more batteries are coupled together.

2. The battery of claim 1, wherein the terminal is crimped.

3. The battery of claim 1, wherein the two or more batteries are coupled together end to end.

4. The battery of claim 3, further comprising an insulator cap provided between adjacent batteries, the insulator cap configured to connect two adjacent batteries.

5. The battery of claim 4, wherein the insulator cap has an aperture through which the protrusion of one battery may contact the terminal of an adjacent battery.

6. The battery of claim 3, wherein the second end has a weakened area, the weakened area configured to break away from the second end to relieve gas pressure inside the battery.

7. The battery module of claim 6, wherein the weakened area is created by scoring the second end.

8. The battery module of claim 6, wherein the weakened area is made up of a material different than the material of the second end.

9. The battery of claim 6, wherein the insulator cap has a recess configured to receive the weakened area of the second end when the weakened area breaks away from the second end so that the weakened area does not contact the adjacent battery when the weakened area breaks away from the second end.

10. The battery of claim 9, wherein the insulator cap has a second aperture adjacent and in fluid communication with the recess, the second aperture configured to allow gas or effluent to escape the battery once the weakened area breaks away from the second end.

11. The battery of claim 4, wherein the insulator cap prevents the housings of adjacent batteries from contacting one another.

12. A battery module, comprising:
a first battery comprising
a housing;
a first end having a terminal having a recess; and
a second end opposite the first end, the second end having a protrusion;
a second battery comprising
a housing;
a first end having a terminal having a recess; and
a second end opposite the first end, the second end having a protrusion;
wherein the protrusion of the second battery is received in the recess of the first battery when the batteries are coupled end to end.

13. The battery module of claim 12, further comprising a connector configured to connect the first battery to the second battery.

14. The battery module of claim 13, wherein the connector is made from a non-conductive material.

15. The battery module of claim 13, wherein the connector comprises an aperture through which the protrusion of the first battery may contact the terminal of the second battery.

16. The battery module of claim 13, wherein the second end of the first battery has a weakened area, the weakened area configured to break away from the second end of the first battery to relieve gas pressure inside the first battery.

17. The battery module of claim 16, wherein the connector has a recess configured to receive the weakened area of the second end when the weakened area breaks away from the second end of the first battery so that the weakened area does not contact the second battery when the weakened area breaks away from the second end of the first batter.

18. The battery module of claim 17, wherein the connector has a second aperture adjacent and in fluid communication with the recess, the second aperture configured to allow gas or effluent to escape the first battery once the weakened area breaks away from the second end of the first battery.

19. The battery module of claim 16, wherein the weakened area is created by scoring the second end.

20. The battery module of claim 16, wherein the weakened area is made up of a material different than the material of the second end.
